(19) United States
(12) Patent Application Publication
(10) Pub. No.: US 2007/0173426 A1
(43) Pub. Date: Jul. 26, 2007

(54) Masonry stain resistance agents

(76) Inventors: John M. Longoria, Wilmington, DE (US); Ernest B. Wysong, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/650,069

(22) Filed: Jan. 5, 2007

Related U.S. Application Data
(60) Provisional application No. 60/762,239, filed on Jan. 26, 2006.

(51) Int. Cl. C11D 3/20

(52) U.S. Cl. 510/238; 510/301

(57) ABSTRACT

A method of treating a substrate comprising providing stain resistance to a substrate by contacting the substrate with a composition comprising a mixture, of A) an anionic aqueous fluoroalkyl phosphate solution, and B) a cationic copolymer of fluoroalkyl(meth)acrylate or perfluoroalkylether(meth)acrylate.

### FIELD OF THE INVENTION

The present invention relates to treatment systems for hard surfaced materials that provide stain resistance wherein the treatment agent contains both anionic and cationic components.

### BACKGROUND OF THE INVENTION

Stone, masonry, concrete, unglazed tile, brick, porous clay and various other substrates with surface porosity are used decoratively in the indoor and exterior environment. However, oils, hydraulic fluids, and oily and aqueous foodstuffs, including, for instance, oils, coffee, ketchup, salad dressings, mustard, red wine, other beverages, and fruit preserves easily stain such surfaces. Many of the prior art treatments, such as clear sealants based on polyurethanes or epoxies, disadvantageously alter the appearance of the substrate. Such sealants can also trap moisture within the treated substrate, promoting spalling.

Longoria et al. in U.S. Pat. No. 6,271,289, describe a composition providing stain resistance to stone, masonry and other surfaces comprising a mixture of anionic fluoroalkylphosphates and anionic fluoroacrylate polymers. It is desirable to have compositions wherein the anionic phosphate can be combined with cationic polymers that provide superior stain resistance.

Miller et al., in U.S. Ser. No. 11/200598 [Docket No. CH-2936] describe aqueous blends comprising anionic fluoroalkylphosphates and cationic fluoroacrylate polymers. Miller's anionic/cationic blends, when applied to substrates, provided a combination of improved water repellency and absence of etching of calcium carbonate substrates. Conventional commercial dispersions and dispersions having a low pH tend to etch marble and other calciferous substrates. A substrate of interest was polished marble, a substrate that is particularly vulnerable to etching due its specular surface. Miller et al. teach increasing the fluorine content of their compositions if stain resistance is important, which is not economical.

With the exception of calciferous surfaces, particularly polished marble, elimination of etching is generally a minor concern compared with stain resistance, a highly desirable property. Additionally, it is desirable to improve the performance of the protective coatings applied to substrates without increasing the fluorine content, such as in a composition wherein the combination provides superior performance results to either component alone.

It is desirable to have compositions wherein the anionic phosphate is combined with cationic polymers to provide improved stain resistance. The present invention provides such compositions.

### SUMMARY OF THE INVENTION

The present invention comprises a method of treating a substrate comprising providing stain resistance to a substrate by application of a composition comprising an aqueous first mixture of

A. an anionic aqueous fluoroalkylphosphate solution comprising

1) a second mixture of Formula IA of mono(perfluoroalkyl) phosphate and bis(perfluoroalkyl) phosphate,

[R_{f}—(O)ⱼ]ₓ—P(O)—(O⁻X⁺)₍₃₋ₓ₎ Formula 1A

wherein:
R_{f} is selected from the group consisting of
F(CF₂CF₂)_{d}(CH₂)ₐ—,
F(CF₂CF₂)_{d}CH₂CH₂(OCH₂CH₂)_{b}—,
F(CF₂CF₂)_{d}—,
F(CF₂CF₂)_{d}CH═CH(CH₂)_{c}—, and
C₈F₁₇SO₂N(R⁵)CH₂CH₂—;
a is from about 2 to about 10,
b is from about 3 to about 20,
c is from about 2 to about 20,
d is 1 to about 8, or a mixture thereof,
R⁵ is H or an aliphatic group containing 1 to about 4 carbon atoms,
x is from about 1 to about 2,
j is 1 or 0, or a mixture thereof, and
X is hydrogen or M,
M is an ammonium ion, an alkali metal ion, or an alkanolammonium ion, or

2) a phosphate of the structure of Formula IB

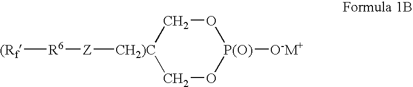

wherein
R_{f}′ is a linear or branched fluoroaliphatic or fluoroalkylether group having from about 2 to about 20 carbon atoms,
R⁶ is an alkylene group having from 1 to about 8 carbon atoms,
Z is —O—, —S—, or —NH—, and
M is as defined above in Formula IA, and

B. a cationic fluoroalkyl(meth)acrylate or perfluoroalkylether (meth)acrylate copolymer comprising monomers copolymerized in the following percentages by weight:

(a) from about 40% to about 92% of at least one monomer of formula 2A

R_{f}′-Q-A-C(O)—C(R⁷)═CH₂ 2A

wherein:
R_{f}′ is a linear or branched fluoroaliphatic or fluoroalkylether group having from about 2 to about 20 carbon atoms,
R⁷ is H or an aliphatic group containing 1 to about 4 carbon atoms,
A is O, S or NR¹ wherein R¹ is H or an alkyl of 1 to about 4 carbon atoms, and
Q is alkylene of 1 to about 15 carbon atoms, hydroxyalkylene of 3 to about 15 carbon atoms, —(CₙH₂ₙ)(OC_{q}H_{2q})ₘ—, —SO₂—NR¹(CₙH₂ₙ)—, or —CONR¹(CₙH₂ₙ)—, wherein R¹ is H or alkyl of 1 to about 4 carbon atoms,
n is 1 to about 15, q is 2 to about 4, and m is 1 to about 15;

(b) from about 1% to about 50% of a monomer of formula 2B

(CH₂═C(R⁷)COW(CH₂)ᵣ⁺NR²R³R⁴)Y— 2B

wherein
R⁷ is H or an aliphatic group containing 1 to about 4 carbon atoms,
R² and R³ are each independently alkyl of 1 to about 4 carbon atoms, hydroxyethyl, or benzyl or R² and R³ together with the nitrogen atom form a morpholine, pyrrolidine, or piperidine ring,
R⁴ is H or alkyl of 1 to about 4 carbon atoms or R², R³, and R⁴ together with the nitrogen form a piperidine ring,
W is —O— or —NR⁴—
r is 2 to 4, and
Y^{—} is an anion, provided that the nitrogen is from about 40% to 100% quaternized;

(c) from 0% to about 20% of an anionic monomer or a monomer which is potentially anionic by varying the pH;

(d) from 0% to about 10% of a vinyl derivative of formula 2C

R⁸—CH═CH₂ 2C

wherein
R⁸ is an alkyl carboxylate or alkyl ether group containing from 1 to about 18 carbon atoms;

(e) from 0% to about 25% of at least one monomer of formula 2D

CH₂═C(R⁹)—C(O)—O—V—OH 2D

wherein
R⁹ is H or an alkyl of 1 to about 4 carbon atoms, and
V is an alkylene of from about 2 to about 4 carbon atoms; and

(f) from 0% to about 30% of any monomer other than the
monomers of components (a) to (e) described above; provided that the weight percents for components (a) to (f) described above total 100%.

The present invention further comprises a substrate treated in accordance with the above described method.

### DETAILED DESCRIPTION

Herein, trademarks are shown in upper case.

The term “(meth)acrylate”, as used herein, indicates either acrylate or methacrylate.

The term “substrate surfaces”, as used herein, includes porous surfaces, such as stone, masonry, concrete, unglazed tile, brick, porous clay and various other substrates with surface porosity. Specific examples of such substrates include unglazed concrete, brick, tile, stone (including granite, limestone and marble), grout, mortar, statuary, monuments, wood, composite materials such as terrazzo, and wall and ceiling panels including those fabricated with gypsum board. These are used in the construction of buildings, roads, parking ramps, driveways, floorings, fireplaces, fireplace hearths, counter tops, and other decorative uses in interior and exterior applications.

The present invention comprises a method of providing stain resistance to a substrate using fluorinated aqueous mixtures comprising a mixture of (1), an anionic aqueous fluoroalkyl phosphate solution and (2), a cationic copolymer of fluoroalkyl(meth)acrylate or perfluoroalkylether (meth)acrylate, preferably in the form of an aqueous dispersion.

The mixtures used in the present invention, when applied to substrate surfaces, provide stain resistance. Both the specific solution and dispersion components and the ratios of components are varied to enhance the desired stain resistance. The mixture of components used in the present invention provide enhanced stain resistance compared to either individual component alone. The ratios of the components are optimized to best suit the surface being treated.

The aqueous composition used in the method of the present invention comprises a first mixture, preferably at a pH of from about 7 to about 10, of

A. an anionic aqueous fluoroalkyl phosphate solution comprising

1) a second mixture of Formula IA of mono(perfluoroalkyl) phosphate and bis(perfluoroalkyl) phosphate,

[R_{f}—(O)ⱼ]ₓ—P(O)—(O⁻X⁺)₍₃₋ₓ₎ Formula 1A

wherein:
R_{f} is selected from the group consisting of
F(CF₂CF₂)_{d}(CH₂)ₐ—,
F(CF₂CF₂)_{d}CH₂CH₂(OCH₂CH₂)_{b}—,
F(CF₂CF₂)_{d}—,
F(CF₂CF₂)_{d}CH═CH(CH₂)_{c}—, and
C₈F₁₇SO₂N(R⁵)CH₂CH₂—;
a is from about 2 to about 10, and preferably is 2
b is from about 3 to about 20, and preferably is from about 6 to about 13,
c is from about 2 to about 20, and preferably is 8
d is 1 to about 8, or a mixture thereof, and preferably is from about 3 to about 6,
R⁵ is H or an aliphatic group containing 1 to about 4 carbon atoms,
x is from about 1 to about 2,
j is 1 or 0, or a mixture thereof, and
X is hydrogen or M,
M is an ammonium ion, an alkali metal ion, or an alkanolammonium ion, such as ethanolammonium or diethanolammonium, and is preferably ammonium, or

2) a phosphate of the structure of Formula IB

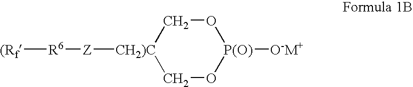

wherein
R_{f}′ is a linear or branched fluoroaliphatic or fluoroalkylether group having from about 2 to about 20 carbon atoms,
R⁶ is an alkylene group having from 1 to about 8 carbon atoms, and is preferably ethylene,
Z is —O—, —S—, or —NH—, and
M is as defined above in Formula IA, and

B. a cationic fluoroalkyl(meth)acrylate or perfluoroalkylether (meth)acrylate copolymer comprising monomers copolymerized in the following percentages by weight:

(a) from about 40% to about 92% of at least one monomer of formula 2A

R_{f}′-Q-A-C(O)—C(R⁷)═CH₂ 2A

wherein:
R_{f}′ is a linear or branched fluoroaliphatic or fluoroalkylether group having from about 2 to about 20 carbon atoms,
R⁷ is H or an aliphatic group containing 1 to about 4 carbon atoms.
A is O, S or NR¹ wherein R¹ is H or an alkyl of 1 to about 4 carbon atoms, and
Q is alkylene of 1 to about 15 carbon atoms, hydroxyalkylene of 3 to about 15 carbon atoms, —(CₙH₂ₙ)(OC_{q}H_{2q})ₘ—, —SO₂—NR¹(CₙH₂ₙ)—, or —CONR¹(CₙH₂ₙ)—, wherein R¹ is H or alkyl of 1 to about 4 carbon atoms, n is 1 to about 15, q is 2 to about 4, and m is 1 to about 15;

(b) from about 1% to about 50% of a monomer of formula 2B

(CH₂═C(R⁷)COW(CH₂)ᵣ+NR²R³R⁴)Y⁻ 2B

wherein
R⁷ is H or an aliphatic group containing 1 to about 4 carbon atoms,
R² and R³ are each independently alkyl of 1 to about 4 carbon atoms, hydroxyethyl, or benzyl or R² and R³ together with the nitrogen atom form a morpholine, pyrrolidine, or piperidine ring,
R⁴ is H or alkyl of 1 to about 4 carbon atoms or R², R³, and
R⁴ together with the nitrogen form a piperidine ring,
W is —O— or —NR⁴—
r is 2 to 4, and
Y⁻ is an anion,
   provided that the nitrogen is from about 40% to 100% quaternized;

(c) from 0% to about 20% of an anionic monomer or a monomer which is potentially anionic by varying the pH; such as alkene carboxylic acids (for example, (meth)acrylic acid), monoolefinic derivatives of sulfonic acid (for example acrylamidomethyl propane sulfonic acid), and their salts of alkali or alkaline-earth metals;

(d) from 0% to about 10% of a vinyl derivative of formula 2C

R⁸—CH═CH₂ 2C

wherein
R⁸ is an alkyl carboxylate or alkyl ether group containing from 1 to about 18 carbon atoms;

(e) from 0% to about 25% of at least one monomer of formula 2D

CH₂═C(R⁹)—C(O)—O—V—OH 2D

wherein
R⁹ is H or an alkyl of 1 to about 4 carbon atoms, and
V is an alkylene of from about 2 to about 4 carbon atoms; and

(f) from 0% to about 30% of any monomer other than the monomers of components (a) to (e) described above; provided that the weight percents for components (a) to (f) described above total 100%.

The fluoroalkylphosphates of component A of the composition used in the present invention are prepared according to the method described by Longoria et al in U.S. Pat. No. 6,271,289, and Brace and Mackenzie, in U.S. Pat. No. 3,083,224 each herein incorporated by reference. Typically, is either phosphorus pentoxide (P₂O₅) or phosphorus oxychloride (POCl₃) are reacted with the fluoroalcohols to give mixtures of the mono- and bis(fluoroalkyl)phosphoric acids. Neutralization, using a base, such as at least one alkanolamine, provides the corresponding phosphates. Reacting an excess of fluoroalcohol with P₂O₅ followed by neutralization provides an equimolar mixture of mono(fluoroalkyl)phosphate and bis(fluoroalkyl)phosphate. Higher ratios of bis(fluoroalkyl)phosphate to mono(fluoroalkyl)phosphate are obtained by using the method of Hayashi and Kawakami in U.S. Pat. No. 4,145,382.

An example of a compound of Formula 1A is the reaction product formed from the partial esterification of a fluoroalcohol mixture of perfluoroalkylethyl alcohols and phosphoric acid that is largely, but not completely, in the form of the diethanolamine salt and having the formula:

(R_{f}CH₂CH₂O)ₓPO[OH]_{(3-x-y)}[O⁻⁺NH₂(CH₂CH₂OH)₂]_{y}.

The various molar ratios of the fluoroalcohol, phosphoric acid, and 30 diethanolamine are identified by the format (x:1:y), thus the (2:1:1) salt is the bis(perfluoroalkylethyl) phosphate diethanolamine salt, the (1:1:2) salt is the perfluoroalkylethyl phosphate bis(diethanolamine salt) and the (1:1:1) salt is the perfluoroalkylethyl phosphate diethanolamine salt.

Another example of a compound of Formula 1A is the reaction product formed from the partial esterification of a fluoroalcohol mixture of perfluoroalkylethyl alcohols and phosphoric acid that is largely, but not completely, in the form of the ammonium salt and having the formula:

(R_{f}CH₂CH₂O)ₓPO[OH]_{(3-x-y)}[O⁻⁺NH₄]_{y}.

The salts of the fluoroalkylphosphates are preferred over the corresponding acids by reason of their increased water solubility.

Preferably, the fluoroalkylphosphate component does not contain non-volatile solvents, such as ethylene glycol, or surfactants, such as alkoxypolyethyleneoxyethanol. In particular for the ammonium salt, it has been found that excellent stain resistance is obtained with out increasing the fluorine levels when such non-volatile solvents and surfactants are absent.

The cationic copolymers of component B of the composition used in the present invention are prepared using various methods, generally, by polymerization of a monomer mixture. The copolymers are prepared by copolymerization of the monomers in solution in a distillable organic solvent. The term “distillable” solvent is understood to mean any organic solvent or solvent mixture whose boiling point at atmospheric pressure is less than 150° C. Next, the reaction mixture is diluted with water in the presence of a mineral or organic acid in order to quaternize the macromolecules. According to one variant in the preparation of these copolymers, this dilution step is carried out in the presence of hydrogen peroxide or is followed by a treatment by means of an aqueous hydrogen peroxide solution.

Preferably in the fluoromonomer, R_{f}′ is a straight chain perfluoroalkyl group of 2 to about 20 carbon atoms, A is O, and Q is an alkylene of 1 to about 15 carbon atoms. Suitable monomers include

CF₃CF₂(CF₂)ₓC₂H₄OC(O)—C(H)═CH₂ or

CF₃CF₂(CF₂)ₓC₂H₄OC(O)—C(CH₃)═CH₂

wherein x is an even integer of from 2 to about 18, or mixtures thereof. More preferably the fluoromonomer is a perfluoroalkylethyl acrylate or methacrylate, with a perfluorocarbon chain length (R_{f}′) distribution predominantly in the range of 6 to 14 carbons.

The most preferred perfluoroaliphatic monomer of formula 2A is that wherein R⁷ is CH₃, and R_{f}′ is a mixture of perfluoroalkyl groups, CF₃CF₂(CF₂)ₛ—, wherein s is 2, 4, 6, 8, 10 and 12 in the approximate weight percent of 2, 35, 30, 18, 8, 3 respectively. Such a monomer has a weight average molecular weight of about 522. The corresponding acrylate monomer has a weight average molecular weight of about 508.

For these cationic copolymers, one preferred embodiment is to polymerize:

(a) the compounds of formula:

R_{f}′—CH₂CH₂—O—CO—CH═CH₂

wherein
R_{f}′ is a perfluoroalkyl radical containing from about 4 to about 20 carbon atoms;

(b) dialkylaminoalkyl acrylate or a dialkylaminoalkyl methacrylate, or corresponding acrylamide or methacrylamide, as either the amine or quaternary ammonium salt.

(c) methacrylic acid as monomer; and

(d) vinyl acetate.

The fluoromonomers of formula 2A are prepared according to known processes, for example by esterification of the corresponding polyfluoro alcohols of formula

R_{f}′—X—OH

wherein R_{f}′ is as defined above in Formula IB and X is a connecting group, using an alkenecarboxylic acid of formula

HO—CO—CR═CH—R

wherein each R is independently hydrogen or a C₁ to about C₂ alkyl group, such as, for example, acrylic acid, methacrylic acid or crotonic acid, in the presence of a catalyst such as sulfuric acid or p-toluenesulfonic acid. Instead of the alkenecarboxylic acids, the esters, anhydrides or halides thereof are also suitable for use. Examples of polyfluoro alcohols, detailing suitable connecting groups X, include, in particular those below:

R_{f}′—(CH₂)p—SO₂NR—(CH₂)q—OH

R_{f}′—SO₂NR—(CH₂)_{q}—OH

R_{f}′—(CH₂)ₚ—OH

R_{f}′—(CH₂)ₚ—O—(CH₂)_{q}—OH

R_{f}′—(CH₂)ₚ—S—(CH₂)_{q}—OH

R_{f}′—(CH₂)ₚ—(O—CH₂CH₂)_{q}—OH

R_{f}′—(CH₂)ₚ—SO₂—(CH₂)_{q}—OH

R_{f}′—CO—NR—(CH₂)ₚ—OH

R_{f}′—CO—O—(CH₂)ₚ—OH

R_{f}′—CH=CH—(CH₂)ₚ—OH

in which R_{f}′ and R have the same meanings as above, and the symbols p and q, which are identical or different, each represent an integer ranging from 1 to 20 and, preferably, are equal to 2 or 4. Alternatively, the fluoromonomers of formula 2A are prepared by tranesterification with methyl acrylate or methyl methacrylate, for example, as described in U.S. Pat. No. 3,282,905.

Examples of monomers of formula 2A are the acrylates and methacrylates of the following amino alcohols: 2-dimethylaminoethanol, 2-diethylaminoethanol, 2-dipropylaminoethanol, 2-diisobutylaminoethanol, 2-N-tert-butylaminoethanol, 2-(N-tert-butyl-N-methylamino)ethanol, 2-morpholinoethanol, 2-(N-methyl-N-dodecylamino)ethanol, 2-(N-ethyl-N-octadecylamino)ethanol, 2-[N-ethyl-N-(2-ethylhexyl)amino]ethanol, 2-piperidinoethanol, 2-(1-pyrrolidinyl)ethanol, 3-diethylamino-1-propanol, 2-diethylamino-1-propanol, 1-dimethylamino-2-propanol, 4-diethylamino-1-butanol, 4-diisobutylamino-1-butanol, 1-dimethylamino-2-butanol, 4-diethylamino-2-butanol. These esters may be prepared, for example, according to the method described in U.S. Pat. No. 2,138,763. The preferred monomer of formula 2A is dimethylaminoethyl methacrylate or N-tert-butylaminoethyl methacrylate.

The preferred monomer of the structure of formula 2B is a dialkylaminoalkyl acrylate or a dialkylaminoalkyl methacrylate, or corresponding acrylamide or methacrylamide, as either the amine or quaternary ammonium salt. Mixtures of the various salt forms are also operable herein. A preferred amine salt monomer is:

CH₂═C(R⁷)CO₂CH₂CH₂N⁺H(C₂H₅)₂Y⁻

wherein R⁷ and Y are as previously defined in formula 2B.

Preferred quaternary ammonium monomers are:

CH₂═C(R⁷)CO₂CH₂CH₂N⁺(CH₃)(C₂H₅)₂Y⁻ and

CH₂═C(R⁷)CONHCH₂CH₂CH₂N⁺(CH₃)₃Y⁻

wherein R⁷ and Y are as previously defined in formula 2B.

Preferably the quaternizable monomer of formula 2B is at least 40% quaternized for adequate solubilizing effect, but may be as high as 100% in this form. The quaternization is performed on the copolymer containing the free amine, or is carried out on the amine group before polymerization with equally good results.

The copolymer is quaternized using strong or moderately strong inorganic or organic acids, whose dissociation constant or whose first dissociation constant is greater than 10⁻⁵. These include hydrochloric acid, hydrobromic acid, sulfuric acid, nitric acid, phosphoric acid, acetic acid, formic acid, propionic acid or lactic acid. Acetic acid is preferably used. The copolymer is quaternized using suitable agents such as an acetate, halide, sulfate or other known quaternizing groups. Examples include methyl iodide, ethyl iodide, dimethyl sulfate, diethyl sulfate, benzyl chloride, trimethyl phosphate or methyl p-toluenesulfonate.

The amine salt monomers are prepared by reacting the corresponding tertiary dialkylaminoalkyl acrylate or dialkylaminoalkyl methacrylate ester or corresponding acrylamide or methacrylamide with an organic or inorganic acid, such as hydrochloric, hydrobromic, sulfuric or acetic acid. The tertiary dialkylaminoalkyl acrylate or dialkylaminoalkyl methacrylate esters are known in the art and can be prepared by either reacting a tertiary amine alcohol of the formula, HO(CH₂)ᵣNR²R³, wherein r is 2 to 4, and R² and R³ are as previously defined in formula 2B, with acryloyl or methacryloyl halide or, preferably, by transesterification with methyl acrylate or methyl methacrylate.

The tertiary dialkylaminoalkyl acrylamides or methacrylamides are prepared by acylating the corresponding dialkylaminoalkyl amine with acryloyl or methacryloyl halide in the presence of an acid acceptor such as triethylamine or pyridine.

The quaternary ammonium monomers are prepared by reacting the aforesaid acrylate or methacrylate esters or corresponding acrylamide or methacrylamide with a di-(lower alkyl) sulfate, a lower alkyl halide, trimethylphosphate or triethylphosphate. Dimethyl sulfate and diethyl sulfate are preferred quaternizing agents.

The nature of the anion, Y⁻, in formula 2B, and in the quaternary ammonium and amine salt monomer is, in general, determined by the method of synthesis. Usually, Y⁻ is a halide ion, such as chloride, bromide, or iodide, or an acetate ion, sulfate ion, phosphate ion, or an alkylsulfate ion. It is known, however, that quaternary ammonium salts can also be prepared by reacting a tertiary amine with an alkyl ester of benzene or toluenesulfonic acid; in such event, Y⁻ is a benzenesulfonate or toluenesulfonate anion.

The copolymers of component B of the composition used in the present invention are obtained by polymerizing the monomers by conventional solvent polymerization techniques. Any of the conventional neutral solvents such as ethyl acetate, acetone, 1,2-dichlorotetrafluoroethane, 1,1,2-trichloro-1,2,2-trifluoroethane, tetrahydrofuran, dioxane, dimethylformamide, N-methyl-2-pyrrolidone, dimethyl sulfoxide, ethyl acetate, isopropyl acetate, butyl acetate, methylethylketone, ethanol, isopropanol, methylisobutylketone, glycol ethers, or other ketones, esters and alcohols and mixtures thereof can be used. As polymerization solvent, it is preferred to use isopropanol, N-methyl-2-pyrrolidone (NMP), acetone or an NMP/acetone binary mixture. The total concentration of monomers may range from 5 to 60% by weight. The copolymer solutions can be diluted, if desired, with polymerization solvent and/or water. Alternatively, the copolymers can be isolated by removal of solvent. After polymerization, the above solvent can be retained in the final composition if required for an intended application, or it can be removed by distillation to form a waterborne composition with a very low volatile organic content. A dispersion of the composition is prepared using conventional means known to those skilled in the art.

The polymerization is carried out in the presence of one or more initiators which are used to a proportion of 0.1 to 1.5% relative to the total weight of monomers employed. Initiators which may be used are peroxides such as, for example, benzoyl peroxide, lauroyl peroxide, succinyl peroxide and tert-butyl perpivalate, or azo compounds such as 2,2′-azobisisobutyronitrile, 4,4′-azobis(4-cyanopentanoic acid) and azodicarbonamide. Such azo initiators are sold by E. I. du Pont de Nemours and Company, Wilmington, Del., commercially under the name of “VAZO” 67, 52 and 64, and by Wako Pure Industries, Ltd., under the name “V-501”. The process may also be performed in the presence of UV radiation and photo-initiators such as benzophenone, 2-methylanthraquinone or 2-chlorothioxanthone.

Conventional chain transfer agents, such as allyl mercaptans (preferably dodecylmercaptan), carbon tetrachloride, triphenylmethane, isooctyl thioglycolate, and crosslinking agents, such as ethylene dimethacrylate, can be used in amounts of 0.1 to 2 percent by weight of the monomers to control the molecular weight of the polymer.

The reaction temperature varies within a wide range, that is to say between room temperature and the boiling point of the reaction mixture. The process is preferably performed between about 60° and about 90° C.

The composition of the copolymers is preferably in the form of a dispersion. It is typically employed as an aqueous dispersion.

Other monomers may optionally be incorporated into the copolymers to provide adhesion to specific substrate surfaces, impart film formation properties, provide stability at wider pH ranges, or provide compatibility with added solvents for specific applications. This optional monomer is any polymerizable monomer described above as components (c), (d) or (e). Up to about 20%, and preferably from1 to about 10%, of an anionic monomer or a monomer which is potentially anionic by varying the pH may be optionally incorporated. Such monomers include alkene carboxylic acids (for example, (meth)acrylic acid), monoolefinic derivatives of sulfonic acid (for example acrylamidomethyl propane sulfonic acid), and their salts of alkali or alkaline-earth metals. Up to about 10% of a vinyl derivative of formula 2C, and up to about 25% of a monomer of formula 2D, may also be incorporated into the copolymers. Examples of such include crosslinkable monomers such as glycidyl (meth)acrylate, (blocked) isocyanatoalkyl-(meth)acrylates, and acrylamides, vinyl monomers such as vinylidene chloride, alkyl (meth)acrylates such as ethylhexyl methacrylate and stearyl methacrylate, ionomers such as (meth)acrylic acid and sulfatoalkyl(meth)acrylates, nonionic water-soluble monomers such as polyoxyethylene (meth)acrylates, and aromatics such as styrene and vinyl toluene.

Preferably, the copolymer component does not contain non-volatile solvents, such as ethylene glycol, or surfactants, such as alkoxypolyethyleneoxyethanol. Excellent stain resistance is obtained without increasing fluorine levels when such non-volatile solvents and surfactants are absent.

The composition used in the method of the present invention ready for application to the substrate surface, comprises a mixture of at least one anionic fluorophosphate and at least one cationic fluorocopolymer. The ratio of fluorophosphate solids to fluorocopolymer solids is from about 95:5 to about 5:95, preferably from about 95:5 to about 50:50. A specific preferred ratio is about 50:50, more preferably about 75:25, more preferably about 80:20, and more preferably about 90:10. The compositions, as applied, are based on a total weight of 50 g, including water. Water, in an amount sufficient to provide the desired water content of the final mixture, is typically added to the cationic copolymer and mixed thoroughly. The fluoroalkyl phosphate is then added to the mixture of water and cationic copolymer and stirred or homogenized.

The pH of the blended composition is preferably between about 7 and about 10, and adjustments to the blend are made if necessary to be within this pH range. This pH adjustment is made using the acid or base already present.

Since the composition used in the present invention is a mixture of an anionic solution and a cationic dispersion, care is necessary in the preparation process to avoid coagulation or irreversible precipitation during the mixing stage. The addition of the fluoro(meth)acrylate polymer dispersion to the fluoroalkyl phosphate solution is prone to cause coagulation and is not recommended. Water, in an amount sufficient to provide the desired water content of the final mixture, is added to the cationic copolymer and mixed thoroughly. The amount of water added per 50 g of composition of the present invention is equal to 50 minus the total weight in g of components A and B. Addition of the anionic fluoroalkyl phosphate solution to the water-diluted cationic fluoro(meth)acrylate polymer dispersion is recommended to minimize coagulation. The mixture is conducted at ambient temperature and pressure. Ideally, the components are mixed in the above order and then passed though a homogenizer. Where a homogenizer is used, samples are preferably homogenized at about 4000 psi (27.6 MPa) for 2 passes in an APV Gaulin, Inc. Model 15MR Homogenizer, available from APV Americas, Lake Mills, Wis. At the second pass the temperature of each sample is typically about 38° C. Those skilled in the art will know there are many other equivalent homogenizers that may be substituted. Typically a homogenizer is preferred but not required for preparing smaller volumes, such as laboratory mixtures with volumes of 1 L or less. The mixture is prepared at a ready-to-apply concentration (treating composition), or at a higher concentration for subsequent dilution prior to application.

Optionally, the mixture used in the present invention may further comprise up to 10% by weight but preferably not more than 3% by weight of one or more water-miscible organic solvents such as alcohols, ketones and esters to improve penetration, drying and the stability of the emulsion. Examples include ethanol, methylisobutylketone and isopropyllactate. Organic solvents in the mixtures are preferably kept at a minimum for health, safety, pollution, and ecological reasons.

The mixture used in the present invention also optionally further comprises conventional additives which are compatible with the mixture in aqueous solution or self-dispersed emulsion or dispersion form. In particular, the mixture additionally contains a microbiocide. Suitable microbiocides are well known to those skilled in the art. A preferred microbiocide is PROXEL GXL from Avecia, Inc., Wilmington Del.

The method of the present invention of treating a substrate surface to provide stain resistance to the substrate comprises application of the composition described above to the substrate. The composition is applied to the substrate by contacting the composition with the substrate using conventional means, including but not limited to, brush, spray, roller, doctor blade, wipe, and dip techniques, preferably using a first coating, optionally followed by one additional coat using a wet-on-wet technique. More porous substrates may require subsequent additional coats. The wet-on-wet procedure comprises applying a first coat which is allowed to soak into the substrate but not dry (e.g., for about 10-30 minutes) and then applying a second coat. Any subsequent coats are applied using the same technique as described for the second coat. The substrate surface is then allowed to dry under ambient conditions, or the drying can be accelerated by warm air if desired. The wet-on-wet application procedure provides a means to distribute or build up more of the protective coating at the substrate surface. A wet-on-wet application is preferred since, if the previous coat is allowed to dry, it tends to repel subsequent coats. For porous substrates, the coats should saturate the substrate surface.

The present invention further comprises substrates treated according to the method of the present invention. These substrates comprise porous surfaced materials used in interior and exterior construction applications. A wide variety of construction substrates are suitable for use herein. Examples of such materials include unglazed concrete, brick, tile, stone (including granite and limestone), grout, mortar, composite materials such as terrazzo, wall and ceiling panels including those fabricated with gypsum board, marble, statuary, monuments, and wood. The treated substrates have improved stain resistance.

Substrates treatable in the present invention vary widely in their porosity. Less porous materials, such as granite or marble, are less subject to staining, while more porous materials, such as limestone or Saltillo, stain very easily. The present invention is especially suitable for providing stain resistance to more porous substrates. Thus limestone and Saltillo were tested in the Examples herein. A treatment that works well to provide stain resistance to more porous substrates will also work very well for less porous substrates, although the reverse is not true. The present invention provides stain resistance to more porous substrates while not altering their surface appearance.

The method and treated substrates of the present invention are useful in providing stain resistance for a variety of hard surfaces used for interior and exterior construction and decorative purposes. Substrates having surface porosity are especially subject to staining and often difficult to protect without altering the appearance of the surface. The present invention provides a method useful to provide excellent stain resistance to such treated substrates. This excellent stain resistance is obtained without increasing fluorine concentrations compared with conventional perfluorocarbon surface treatment agents. This is achieved because the stain resistance performance of the composition of the present invention exceeds that provided by either component alone. It has been found that a higher ratio of the phosphate component enhances a synergistic effect. This effect works to provide enhanced performance without increasing the fluorine content in the treatment composition. When the phosphate component is present at lower levels this effect is less pronounced, and the stain resistance performance is lower. Thus by adjusting the ratio of the components to have more of the phosphate component then of the copolymer component, the combination will have stain resistance performance that exceeds either component alone, and the fluorine content does not have to be increased to obtain improved performance. This provides the advantage of a treating agent that is more economical in use.

### Materials

The following commercial fluorophosphates and fluorocopolymers were used in the Examples and Comparative Examples.

TABLE 1

| | |
|---|---|
| Component* | Composition |

Aqueous Anionic Fluorophosphates

| | |
|---|---|
| Q1 | Solution of mixed perfluoroalkylethyl phosphate |
| | diethanolamine salts, 16% (1:1:2), 16% (2:1:1), and |
| | 2% (1:1:1), in water and isopropanol |
| Q2 | Solution of mixed perfluoroalkylethyl phosphate |
| | diethanolamine salts, 16% (1:1:2), 16% (2:1:1), and |
| | 2% (1:1:1), in water and isopropanol |
| Q3 | Solution of mixed perfluoroalkylethyl phosphate |
| | ammonium salts, 17–21% (1:1:2), 11–15% (2:1:1), 3–7% |
| | (1:1:1), in water and isopropanol |
| Q4 | Solution of mixed perfluoroalkylethyl phosphate |
| | ammonium salts, 10–14% (1:1:2), 7–11% (2:1:1), 3–7% |
| | (1:1:1), in water |

Aqueous Cationic Fluoroacrylate Copolymers

| | |
|---|---|
| P1 | Aqueous dispersion of copolymer of |
| | perfluoroalkylethylmethacrylate/ |
| | diethylaminoethylmethacrylate, 30% in water |
| P2 | Aqueous dispersion of copolymer of |
| | perfluoroalkylethylacrylate/ |
| | diethylaminoethylmethacrylate/glycidyl methacrylate, |
| | 18.6% in water |
| P3 | Aqueous dispersion of copolymer of |
| | perfluoroalkylethylacrylate/ |
| | diethylaminoethylmethacrylate/glycidyl methacrylate, |
| | 30% in water |
| P4 | Aqueous dispersion of copolymer of |
| | perfluoroalkylethylacrylate/ |
| | dimethylaminoethylmethacrylate/vinyl acetate, 25% in |
| | water, propylene glycol methyl ether, and dipropylene |
| | glycol methyl ether |

*Q1–Q4, and P1–P4 are available from E. I. du Pont de Nemours and Company, Wilmington DE.

### Test Methods

### Substrate Preparation:

Square tiles (12 in. square [30.5 cm square]) of a sample limestone (Chesapeake Golden Beach), and unglazed Saltillo tile (i.e. sun-dried Mexican clay tile) were obtained from Tile Market of Delaware, Wilmington Del. The tiles were divided into eight smaller areas of approximately 90 cm2 each) using vinyl tape on the surface of the tiles.

The limestone samples were rinsed with water to remove any dust or dirt and allowed to dry thoroughly, typically 24 hours or more, before treating solutions were applied as described below. The Saltillo tiles were cleaned with an acidic cleaner (STONETECH Professional RESTORE grout and masonry cleaner from E. I. du Pont de Nemours and Company, Wilmington Del.) and then allowed to dry for 24 hours or more before treating solutions were applied as described below.

### Application of Treating Solutions:

In all Examples, treating solutions were made by diluting the compositions defined in Tables 1 and 2 in deionized water to the desired treating concentration as defined in Table 2. A nylon bristle paintbrush was used to apply the desired amount of treating solution to an area on each substrate. The target application amounts for each substrate reflected how much treating solution the substrate could absorb in a short period of time. Target application amounts were 100 g/m² for limestone and 200 g/m² for Saltillo.

When the targeted weight of application solution was applied to each substrate, the solution readily soaked into the limestone and Saltillo samples. The treated substrates were allowed to dry for at least 24 hours before testing was conducted on these substrates.

### Test Method 1. Determination of Stain Resistance.

The following food stains were placed at intervals on the surface of the treated and dried limestone and Saltillo tiles and allowed to remain on the tile for 24 hours: 1) hot bacon grease, 2) cola, 3) black coffee, 4) grape juice, 5) Italian salad dressing, 6) ketchup, 7) lemon juice, 8) mustard, and 9) Wesson vegetable oil. Sources are shown below:

| Stain | Manufacturer | Location |
|---|---|---|
| Bacon Grease | OSCAR MAYER, Kraft | Northfield, IL |
| | Foods | |
| Cola | COCA-COLA, Coca-Cola | Atlanta, GA |
| | Company | |
| Coffee (black) | FOLGERS, Proctor & | Cincinnati, OH |
| | Gamble | |
| WELCH'S Grape | Welch Foods Inc. | Concord, MA |
| Juice (purple) | | |
| WISHBONE Italian | Unilever | Englewood Cliffs, |
| Salad Dressing | | NJ |
| HEINZ Tomato | H. J. Heinz Company | Pittsburgh, PA |
| Ketchup | | |
| SICILIA Lemon Juice | B & G Srl | Perugia, Italy |
| HEINZ Mustard | H. J. Heinz Company | Pittsburgh, PA |
| WESSON Oil | Conagra Grocery Products | Irvine, CA |
| (soybean) | Company | |

After a 24-hour period, the food stains were blotted or lightly scraped from the tile surface. The tile's surface was rinsed with water and a stiff nylon bristle brush was used to scrub the surface to remove any remaining dried food residue. The tiles were then rinsed with water and allowed to dry for at least 24 hours before rating.

The stains remaining on the tile surfaces after cleaning were rated visually according to a scale of 0 to 4 as follows: 0=no stain; 1=very light stain; 2=light stain; 3=moderate stain; and 4=heavy stain. The ratings for each substrate type are summed for each of the stains to give a composite rating for each substrate. The maximum total score for each substrate was 9 stains times the maximum score of 4 per stain=36. Thus, the maximum composite score for both substrates (limestone and Saltillo) was two times the maximum score per substrate (36)=72. Lower scores indicate better stain protection with scores of 30 or less being acceptable and with zero indicating the best protection with no stain present. The summed results are shown in Table 2 below.

### EXAMPLES

Component codes for fluoroalkyl phosphates and fluoroalkyl(meth)acrylates used in the following Examples are listed under MATERIALS in Table 1 above.

### Example 1

A penetrating solution was prepared by mixing 0.35 g of the cationic polymer P1 as defined in Tables 1 and 2, with 47.05 g of deionized water. The solution was mixed thoroughly and 2.6 g of the anionic phosphate Q1 as defined in Tables 1 and 2 was added, to yield 50.0 g penetrating solution. The penetrating solution contained a solids concentration of 2.0% solids by weight and a fluorine concentration of 1.04% fluorine by weight. The solution was applied to substrates as described in Application of Treating Solutions above. The substrate samples and untreated controls were stained and tested for stain resistance according to Test Method 1 described above. The test was repeated and the composite stain scores were averaged. The test results are shown in Table 2. Example 1 had a very good average stain resistance rating of 19.

### Examples 2-10

Examples 2-10 were prepared and tested as described for Example 1, using cationic polymers and anionic phosphates as described in Tables 1 and 2 in the proportions listed in Table 2. The percent solids and fluorine concentration of the penetrating solution are also shown in Table 2. The example solutions were applied to substrates as described in Application of Treating Solutions above, and tested for stain resistance according to Test Methods 1 and 2 described above. Each example was tested between 2 and 5 times, and the composite stain scores were averaged.

Test results are shown in Table 2. Each of these examples had very good stain resistance.

### Comparative Examples A-D

Comparative Examples A-D contained no fluoroacrylate polymer in the penetrating solution. The fluorophosphate is described in Table 1 and was diluted with deionized water to the same concentration of solids and approximately the same concentration of fluorine as the penetrating solutions in Examples 1-10, as detailed in Table 2. The penetrating solutions were applied to the substrates and tested for stain resistance according to Test Method 1. The results are shown in Table 2. Fluorophosphates alone gave worse staining (i.e., higher stain resistance rating number) than the same fluorophosphates blended with cationic polymers in Examples 1-10.

### Comparative Examples E-H

Comparative Examples E-H contained no fluorophosphates in the penetrating solution. The fluoropolymer is described in Table 1 and was diluted with deionized water to the same concentration of solids and approximately the same concentration of fluorine as the penetrating solutions in Examples 1-10, as detailed in Table 2. The penetrating solutions were applied to the substrates and tested for stain resistance according to Test Method 1. The results are shown in Table 2. Fluoropolymers alone gave worse staining (i.e., higher stain resistance ratings) or in some cases, equal staining, compared to the same fluoropolymers blended with fluorophosphates in Examples 1-10.

TABLE 2

| | | | | | % | | |
|---|---|---|---|---|---|---|---|
| | | | | % | Polymer | | |
| | | | | Phosphate | Solids | | Average |
| | | | % Solids | Solids in | in | % Fluorine | Total |
| | | | in | Total | Total | in | Stain |
| Example | Phosphate | Polymer | Solution | Solids | Solids | Solution | Rating |
| 1 | Q1 | P1 | 2.0% | 89% | 11% | 1.04% | 19 |
| 2 | Q2 | P1 | 2.0% | 89% | 11% | 0.98% | 27 |
| 3 | Q3 | P1 | 2.0% | 89% | 11% | 0.98% | 9 |
| 4 | Q3 | P2 | 2.0% | 90% | 10% | 0.99% | 7 |
| 5 | Q3 | P3 | 2.0% | 90% | 10% | 0.99% | 11 |
| 6 | Q3 | P4 | 2.0% | 90% | 10% | 0.99% | 10 |
| 7 | Q4 | P1 | 2.0% | 89% | 11% | 0.98% | 13 |
| 8 | Q4 | P2 | 2.0% | 89% | 11% | 1.01% | 22 |
| 9 | Q4 | P3 | 2.0% | 90% | 10% | 0.99% | 22 |
| 10 | Q4 | P4 | 2.0% | 90% | 10% | 0.99% | 23 |
| Control* | None | None | NA | NA | NA | NA | 48 |

Comparative Examples, Single Components, Phosphates

| | | | | | | | |
|---|---|---|---|---|---|---|---|
| A | Q1 | None | 2.0% | 100% | 0% | 1.07% | 23 |
| B | Q2 | None | 2.0% | 100% | 0% | 1.00% | 30 |
| C | Q3 | None | 2.0% | 100% | 0% | 1.00% | 18 |
| D | Q4 | None | 2.0% | 100% | 0% | 1.00% | 27 |

Comparative Examples, Single Components, Polymers

| | | | | | | | |
|---|---|---|---|---|---|---|---|
| E | None | P1 | 2.0% | 0% | 100% | 0.88% | 27 |
| F | None | P2 | 2.0% | 0% | 100% | 1.08% | 22 |
| G | None | P3 | 2.0% | 0% | 100% | 0.86% | 25 |
| H | None | P4 | 2.0% | 0% | 100% | 0.86% | 25 |

*Control Example indicates tests on the untreated substrates.

### Examples 11-25

Examples 11-25 were prepared and tested as described for Example 1, using cationic polymers and anionic phosphates as described in Table 1 in the proportions listed in Table 3. The percent solids and fluorine concentration of the penetrating solution are also shown in Table 3. The example solutions were applied to substrates as described in Application of Treating Solutions above, and tested for stain resistance according to Test Methods 1 and 2 described above. Each example was tested once. Test results are shown in Table 3. Each of these examples had very good stain resistance when compared to the untreated control.

TABLE 3
Impact of Blend Ratio on Stain Resistance

| | | | | % | % | | |
|---|---|---|---|---|---|---|---|
| | | | | Phos- | Polymer | | |
| | | | % | phate | Solids | % | |
| | | | Solids | Solids | in | Fluorine | Total |
| | Phos- | Poly- | in | in Total | Total | In | Stain |
| Example | phate | mer | Solution | Solids | Solids | Solution | Rating |
| 11 | Q1 | P1 | 2.0% | 89.0% | 11.0% | 1.02% | 15 |
| 12 | Q1 | P1 | 2.0% | 50.0% | 50.0% | 0.95% | 22 |
| 13 | Q1 | P1 | 2.0% | 5.0% | 95.0% | 0.86% | 21 |
| 14 | Q4 | P1 | 2.0% | 89.0% | 11.0% | 1.02% | 13 |
| 15 | Q4 | P1 | 2.0% | 50.0% | 50.0% | 0.95% | 22 |
| 16 | Q4 | P1 | 2.0% | 5.0% | 95.0% | 0.86% | 24 |
| 17 | Q3 | P1 | 2.0% | 89.0% | 11.0% | 1.02% | 3 |
| 18 | Q3 | P1 | 2.0% | 50.0% | 50.0% | 0.95% | 15 |
| 19 | Q3 | P1 | 2.0% | 5.0% | 95.0% | 0.86% | 25 |
| 20 | Q2 | P1 | 2.0% | 89.0% | 11.0% | 1.02% | 29 |
| 21 | Q2 | P1 | 2.0% | 50.0% | 50.0% | 0.95% | 25 |
| 22 | Q2 | P1 | 2.0% | 5.0% | 95.0% | 0.86% | 20 |
| 23 | Q1 | P2 | 2.0% | 89.0% | 11.0% | 1.04% | 25 |
| 24 | Q1 | P2 | 2.0% | 50.0% | 50.0% | 1.06% | 32 |
| 25 | Q1 | P2 | 2.0% | 5.0% | 95.0% | 1.07% | 31 |
| Control* | NA | NA | NA | NA | NA | NA | 46 |

*Control Example indicates tests on the untreated substrates.

The data is Table 3 shows the effect of different blends of phosphate and polymer on the stain resist performance. Generally as the amount of phosphate increases compared to the amount of polymer, the stain resist performance is enhanced.

What is claimed is:

1. A method of treating a substrate comprising providing stain resistance to a substrate by contacting the substrate with a composition comprising an aqueous first mixture of
A. an anionic aqueous fluoroalkyl phosphate solution comprising
1) a second mixture of mono(perfluoroalkyl) phosphate and bis(perfluoroalkyl) phosphate of Formula IA,
[R_{f}—(O)ⱼ]ₓ—P(O)—(O⁻X⁺)₍₃₋ₓ₎ Formula 1A
wherein:
R_{f} is selected from the group consisting of
F(CF₂CF₂)_{d}(CH₂)ₐ—,
F(CF₂CF₂)_{d}CH₂CH₂(OCH₂CH₂)_{b}—,
F(CF₂CF₂)_{d}—,
F(CF₂CF₂)_{d}CH═CH(CH₂)_{c}—, and
C₈F_{1 7}SO₂N(R⁵)CH₂CH₂—;
a is from about 2 to about 10,
b is from about 3 to about 20,
c is from about 2 to about 20,
d is 1 to about 8, or a mixture thereof,
R⁵ is H or an aliphatic group containing 1 to about 4 carbon atoms,
x is from about 1 to about 2,
j is 1 or 0, or a mixture thereof, and
X is hydrogen or M,
M is an ammonium ion, an alkali metal ion, or an alkanolammonium ion, or
2) a phosphate of the structure of Formula IB 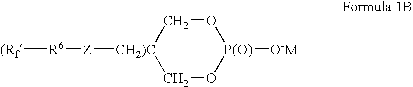
wherein
R_{f}′ is a linear or branched fluoroaliphatic or fluoroalkylether group having from about 2 to about 20 carbon atoms,
R⁶ is an alkylene group having from 1 to about 8 carbon atoms,
Z is —O—, —S—, or —NH—, and
M is as defined above in Formula IA, and
B. a cationic fluoroalkyl(meth)acrylate or perfluoroalkylether (meth)acrylate copolymer comprising monomers copolymerized in the following percentages by weight:
(a) from about 40% to about 92% of at least one monomer of formula 2A
R_{f}′-Q-A-C(O)—C(R⁷)═CH₂ 2A
wherein:
R_{f}′ is a linear or branched fluoroaliphatic or fluoroalkylether group having from about 2 to about 20 carbon atoms,
R⁷ is H or an aliphatic group containing 1 to about 4 carbon atoms,
A is O, S or NR¹ wherein R¹ is H or an alkyl of 1 to about 4 carbon atoms, and
Q is alkylene of 1 to about 15 carbon atoms, hydroxyalkylene of 3 to about 15 carbon atoms, —(CₙH₂ₙ)(OC_{q}H_{2q})ₘ—, —SO₂—NR¹(CₙH₂ₙ)—, or —CONR¹(CₙH₂ₙ)—, wherein R¹ is H or alkyl of 1 to about 4 carbon atoms, n is 1 to about 15, q is 2 to about 4, and m is 1 to about 15;
(b) from about 1% to about 50% of a monomer of formula 2B
(CH₂═C(R⁷)COW(CH₂)ᵣ+NR²R³R⁴)Y⁻ 2B
wherein
R⁷ is H or an aliphatic group containing 1 to about 4 carbon atoms,
R² and R³ are each independently alkyl of 1 to about 4 carbon atoms, hydroxyethyl, or benzyl or R² and R³ together with the nitrogen atom form a morpholine, pyrrolidine, or piperidine ring,
R⁴ is H or alkyl of 1 to about 4 carbon atoms or R², R³, and R⁴ together with the nitrogen form a piperidine ring,
W is —O— or —NR⁴—
r is 2 to 4, and
Y⁻ is an anion,
provided that the nitrogen is from about 40% to 100% quaternized;
(c) from 0% to about 20% of an anionic monomer or a monomer which is potentially anionic by varying the pH;
(d) from 0% to aboutl 0% of a vinyl derivative of formula 2C
R⁸—CH═CH₂ 2C
wherein
R⁸ is an alkyl carboxylate or alkyl ether group containing from 1 to about 18 carbon atoms;
(e) from 0% to about 25% of at least one monomer of formula 2D
CH₂═C(R⁹)—C(O)—O—V—OH 2D
wherein
R⁹ is H or an alkyl of 1 to about 4 carbon atoms, and
V is an alkylene of from about 2 to about 4 carbon atoms; and
(f) from 0% to about 30% of any monomer other than the monomers of components (a) to (e) described above;
provided that the weight percents for components (a) to (f) described above total 100%.

2. The method of claim 1 wherein the fluoroalkyl phosphate solution of component A is a mixture of mono(perfluoroalkyl) phosphate and bis(perfluoroalkyl) phosphate of Formula IA.

3. The method of claim 1 wherein the copolymer of component B is a copolymer prepared by copolymerization of formula 2A and formula 2B.

4. The method of claim 3 wherein component B is a copolymer of perfluoroalkylethyl(meth)acrylate, and dialkylaminoalkyl(meth)acrylate.

5. The method of claim 1 wherein the contacting is by brush, spray, roller, doctor blade, wipe and dip techniques.

6. The method of claim of claim 5 wherein the contacting comprises application of one or more coats of the composition to the substrate.

7. The method of claim 5 wherein the substrate is unglazed concrete, brick, tile, stone, granite, limestone, grout, mortar, composite materials, terrazzo, gypsum board, marble, statuary, monuments, or wood.

8. The method of claim 1 wherein the ratio of fluorophosphates solids to fluorocopolymer solids is from about 95:5 to about 5:95.

9. The method of claim 1 wherein the ratio of fluorophosphates solids to fluorocopolymer solids is from about 95:5 to about 50:50.

10. A substrate treated with the method of claim 1 which is unglazed concrete, brick, tile, stone, granite, limestone, grout, mortar, composite materials, terrazzo, gypsum board, marble, statuary, monuments, or wood.
